(19) United States
(12) Patent Application Publication
(10) Pub. No.: US 2015/0163234 A1
(43) Pub. Date: Jun. 11, 2015

(54) SYSTEM AND METHODS FOR PROTECTING COMPUTING DEVICES FROM MALWARE ATTACKS

(71) Applicant: Six Scan Ltd., Tel Aviv (IL)

(72) Inventors: Yaron Tal, Holon (IL); Nitzan Miron, Zur Yigal (IL); Gregor Freund, San Francisco, CA (US)

(21) Appl. No.: 14/626,148

(22) Filed: Feb. 19, 2015

Related U.S. Application Data
(63) Continuation-in-part of application No. 13/481,964, filed on May 29, 2012.
(60) Provisional application No. 61/942,053, filed on Feb. 20, 2014.

(51) Int. Cl. H04L 29/06

(52) U.S. Cl. CPC H04L 63/145

(57) ABSTRACT

An online protection system and method for actively filtering webpages using a rule-based protective agent such that internet connectable communication devices receive a clean copy of the webpage. The protective agent may be operable to perform rule based filtering of static and web-generated pages. The system includes a data scanner, a report processor and a rule-based logic generator. The protection system may include malware server site scanner to prevent any potential backdoors and possibly introducing remedy to the infected files or quarantining in a non-standard directory locations.

### CROSS-REFERENCE TO RELATED APPLICATIONS

This application is a continuation-in-part of applicant's co-pending U.S. patent application Ser. No. 13/481,964 filed May 29, 2012, and claims the benefit of U.S. Provisional Application Ser. No. 61/942,053, filed Feb. 20, 2014, the disclosures of which are hereby incorporated in their entirety by reference herein.

### FIELD OF THE INVENTION

The disclosure herein relates to internet security. In particular, the disclosure relates to web based systems for protecting from web-based malware (malicious software) attacking servers and users using a rule based access control agent for protection.

### BACKGROUND OF THE INVENTION

Millions of websites are hacked every year, and this trend is on the rise, with both small and large websites may be affected. Common attacks exposing websites to being vulnerable, are known in the art, such as Cross Site Scripting (XSS) allowing the attacker to insert malicious code into the victim's browser and execute script which can hijack user's session, Injections Flaws, particularly drive-by download, redirecting users to malicious website to steal information, cookie, phishing site, malicious file execution and the like. Further, web based malware may have devastating impact on a computing device ranging from simple email advertising, spam of a mail inbox, slow down a connection through to complex identity-theft and password-stealing.

It is noted that the web is a main source of malware attacks and the majority of these attacks come from what is called drive-by download. The term drive-by download describes malware that can infect a computing device simply by visiting a legitimate website that is running malicious code.

Cyber criminals use sophisticated malware packaged in an exploit kit. For example, a drive-by download may be activated from a legitimate infected website or an e-mail with a malicious link. The malware may redirect the user's browser to a malicious website hosting the exploit kit, where the exploit kit may further analyze the system to find several security vulnerabilities. Once the exploit kit identified a vulnerability, then the infection begins and a malicious payload may be downloaded to infect the system. Zbot, a known malware, can access a user's mail or bank account. Sensitive data may be retrieved and reported to base or others attempts may try to exploit system weaknesses.

Furthermore, web-based malware may be configured to inject advertisements into the user's browser and steal views or steal advertising clicks (such as pay per click of Google AdSense). This type of attack is called “Malvertising” and is part of a web-based malware.

Whenever an internet connection is established for surfing, reading your mail or sharing files over the World Wide Web network, the user's system is exposed to malware attacks. There are many channels through which malware can attack a computer and once inside the system, these may spread automatically and disrupts internet traffic as well. Some of these may open access to a user's computer. By way of example, in one event, a malware attack hit an advertising server of a large web portal over several days, affecting thousands of users in various countries. In another event an advertising server was hit by a malware attack, affecting thousands of users in various countries. In this case, clients visiting the URL ‘yahoo.com’ received advertisements served by ‘ads.yahoo.com’ some of these advertisements were malicious.

Malware types may be differentiated according to criteria such as self-distribution, point of control, data stealing, level of protection and the like. The self-distribution is the capability of the malware to spread itself to other computers. Point of control refers to the capability of the malware to be controlled by a central remove server, for example its vulnerability to receiving commands, sending information, automatic updating and the like. Data stealing refers to the capability of the malware to send information from the computer to a remote server.

The level of protection of malware refers to the systems put into place by the malware author in order to decrease detection by end point security products, such as anti-virus software, malware detection software, and the like, and gateway protection software, such as firewalls and the like.

It is noted that the malware is referred to as a code snippet payload and not as an executable application. Some web-based malware are designed to be polymorphic, they use many encoding and code style methods (obfuscation) to be stealth as possible. Some malware may use encryption of the network communication between the malware and a drop zone at a criminal server.

Cyber criminals use various methods to infect machines with malware. Examples include the social engineering, exploitation of specific vulnerabilities, use of exploit kits, distribution of email attachment and the like.

Social engineering is one method for deceiving users into downloading malware. In one example a website which offers to show a video. In order to view the video the user is required to download software purporting to be an update for commonly used software such as Adobe Flash or the like. In reality the update is an executable file installing malware onto the host.

Specific vulnerability may be identified and exploited, certain malicious web pages, for example, exploit known vulnerabilities of a browser, application or operating system in order to install the malware surreptitiously.

Exploit kits are a collections of exploits traded in the underground, and used by cyber criminals to increase the probability of installing the malware surreptitiously.

Email attachments are often used to distribute malware to unsuspecting recipients. For example, executable files may be attached to spam email or email purporting to be from a member of the user's contact list. A botnet generally comprises a set of malware infected computers, or bots, all connected to a common criminal sever, also known as a bot server, or a bot server set comprising a plurality of bot servers. The bot server or bot server set may include a command and control module, which is able to control all the infected computers, an update module which updates the malware code in the infected computers, and a drop zone for collecting data received from the infected computers.

Despite this worrying picture, most website owners today have no easy way to protect their websites, as reasonable protection can only be achieved by using tools that require in-depth technical knowledge, or hiring security specialists, which is prohibitively expensive for all but very large websites, and often too slow and inadequate.

Malware removal requires extensive manual effort, presenting a slow process, which may affect users visiting the infected websites.

There is therefore a need for an effective automatic system for protecting websites and other computing systems connected to the internet from malware attacks. The present disclosure addresses this need.

### SUMMARY OF THE INVENTION

Aspects of the current disclosure provide a protection system that may be placed online on a web server and actively filter the malware attacks from the webpage, thus an internet connectable communication devices may receive a clean copy of the webpage.

Accordingly, it is one aspect of the current disclosure to present a protection system for protecting at least one computing device from malicious software attacking. The at least one computing device may be in communication via a computer network with at least one web server hosting at least one website and operable to generate at least one web page in response to receiving a data request. The protection system comprising:
at least one data scanner operable to scan a file system associated with the at least one website, to identify at least one web-based malware vulnerability, and further operable to generate an automated web-based malware vulnerability report comprising data pertaining to the at least one web-based malware vulnerability; and
at least one report processor operable to analyze said automated web-based malware vulnerability report and further operable to generate at least one software based protective element;

The at least one software based protective element may be associated with at least one protective agent to enforce the desired security.

Where appropriate, the at least one protective agent of the protection system is installed on the at least one web server. Optionally, the at least one protective agent of the protection system may be installed on a remote machine in communication with the at least one web server via the computer network.

Accordingly, the at least one software based protective element of the protection system comprises at least one rule based logic file. Furthermore, the at least one rule based logic file comprising at least one rule associated with the at least one web-based malware vulnerability and operable to prevent exploitation of the at least one web-based malware vulnerability.

Optionally, the protection system further comprising at least one communicator operable to communicate with the at least one protective agent.

As appropriate, the at least one protective agent of the protection system is operable to receive the at least one web page and to generate at least one filtered web page according to the at least one rule based logic file.

Optionally, the at least one protective agent of the protection system is operable to return an error code, possibly in a form of a web page.

As appropriate, the at least one rule of the protective agent comprises instructions to apply a preventative action to the at least one system vulnerability associated with the at least one web page.

Optionally, the preventative action comprises correcting at least a section of the at least one web page containing said at least one system vulnerability.

Optionally, the preventative action comprises deleting at least a section of the at least one web page containing the at least one system vulnerability.

Optionally, the preventative action comprises deleting at least one file encoding the at least one web page.

Optionally, the preventative action comprises quarantining at least one file encoding said at least one web-page in a non-standard zone.

Additionally or alternatively, the protection system may further comprise a controller operable to manage the at least one data scanner and the at least one report processor.

In some embodiments, the protection system may furthermore comprise a controller operable to manage the at least one data scanner, the at least one report processor and the at least one communicator.

Accordingly, the controller may be operable to instruct the at least one data scanner to initiate scanning activity. Further, the protection system may comprise a scheduler unit connectable with the controller and operable to configure a timed schedule for the scanning activity.

In some embodiments of the system, the controller is operable to receive the automated web-based malware vulnerability report from the at least one data scanner and to transfer the automated report to the at least one report processor.

Where appropriate, the controller is operable to receive the at least one rule based logic file from the at least one report processor and further associate the at least one rule based logic file to at least one protective agent component.

Optionally, in some embodiments of the system, the controller is operable to re-direct the at least one web page to the protective agent component via the communicator. Variously, the controller is operable to send at least one web page to the at least one computing device in response to the web server receiving a data request.

According to another aspect of the disclosure, a method is taught, in an improved manner, for protecting a at least one computing device from a malicious software attack, the computing device in communication with at least one web server via a computer network and operable to access at least one website installed on the at least one web server, the method comprising:
the web server, scanning a file system structure associated with the website to identify at least one web-based malware vulnerability;
the web server, creating an automated web-based malware vulnerability report comprising data pertaining to the at least one web-based malware vulnerability;
the web server, generating at least one software based protective element;
the web server, executing at least one protective agent;
the web server, associating the at least one software based protective element with the at least one protective agent.

Accordingly, the step of generating at least one software based protective element, comprises: the web server, generating a rule based logic file comprising at least one rule associated with the at least one web-based malware vulnerability.

Further, the step of scanning a file system structure configuration, may further comprise:
the web server, mapping the file system;
the web server, analyzing mapped file system; and
the web server, identifying at least one web-based malware vulnerability.

Where appropriate, the method may further comprise the step of redirecting the at least one web page to the at least one protective agent.

Accordingly, the at least one protective agent is operable to receive at least one web page, filter at least one web-based malware vulnerability according instructions of the rule based logic file.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a block diagram schematically representing one system for protecting a server from malware attacks by providing a user with a report of potential vulnerabilities;

FIG. 2A is a block diagram illustrating the system components operable from a remote server for protecting malware attacks of a computing device providing web based protective elements operable to be executed on a web server protective agent;

FIG. 2B is a block diagram illustrating the system components for protecting malware attacks of a computing device providing web based protective elements operable to be executed on a web server protective agent;

FIG. 2C is a block diagram schematically representing another system for protecting a user computing device from malware attacks by applying rule based filtering logic;

FIG. 3A is a flowchart illustrating a possible method representing a process for generating a software based protective element providing rule-based access control to enable performing web page filtering;

FIG. 3B is a flowchart illustrating a possible method representing a process for scanning the website associated file structure;

FIG. 4A is a flowchart illustrating another possible method for analyzing a server file directory structure for malware attacks using a web based protection module;

FIG. 4B represents a rule based logic options of a possible set of preventative actions in response to identification of a web-based malware vulnerability by the protective agent; and

FIG. 5 represents a block diagram schematically representing a mechanism for providing web server vulnerability analysis of a file indexing tool.

### DETAILED DESCRIPTION

Aspects of the present disclosure relate to internet security. In particular, the disclosure relates to web based systems for protecting against malware (malicious software) possibly attacking servers and users' computing devices in communication with said web servers.

Optionally, a protection system may be provided for protecting a computing device from hacking attacks. As described herein the protection system may be configured to identify vulnerabilities on the server, automatically generate web-based malware report and provide protective elements therefor.

In one aspect of the current disclosure, a malware protection system is presented for protecting at least one user computing device in communication with a remote web server through a computer network.

The malware protection system may comprise:
at least one data scanning component operable to monitor activities of the web server and to identify at least one web-based malware and produce an automated web-based malware report;
at least one report component operable to analyze and process the web-based malware report; and
at least protective agent comprising at least one software protective element operable to drive the protection rule based logic.

As described herein, the malware protection system may be configured to identify malware security vulnerabilities on the web server side, generating rule-based protecting elements wrapped up into a rule-based module and configured as a front-end component.

Optionally, the rule based module may be installed on a protective agent.

Accordingly, any received web page from a web server is directed through the rule-base module, to undergo filtering and removal of any suspected malware element, returning a ‘malware free’ web page to the user computing device.

As appropriate, the malware filtering provides an immediate first-aid automatic response for any malware presence, preventing any potential hazard to a user computing device. Additionally or alternatively, the immediate response on the user computing device provides for further manual and efficient malware removal on the web server side.

It is noted that the main functions of the malware protection system are to identify malicious activity, generate an associated rule for the specific web-based malware and attempt to block/stop the activity by removing the malicious component such as malicious URL, <iframe> elements and the like.

Optionally, the malware protection system may be configured to log information about the suspect activity and report the activity, online.

For example, scanning of a web server directory structure may identify a possible malware in a web page, such as http://website.com/homepage.php. The malware may be a malicious URL, possibly flagged for removal by a rule. The logic implemented on the client side may indicate that each time the web server is responding to a client request with a file of http://website.com/homepage.php, the file will be searched for the malicious URL and upon detection, an appropriate filtering may be applied to the file in question. The user computing device will receive a filtered file of http://website.com/homepage.php, without the malicious URL. Where appropriate a filter may be applied to all web pages prior to being relayed to the client terminal.

It is noted that rule-based access control may allow to specify which elements within a file should be acted upon, allowing definitions on a very granular level.

Optionally, a rule may be created for removing a URL, deleting paragraphs or sections, blocking access and the like.

In another aspect of the current disclosure, another protection system may be provided for protecting a web server from malware attacks, based upon malicious web server side data scanning. As described herein, the protection system may be configured to perform mapping and further data scanning of the web server file system structure to produce a server web-based malware report, to allow analyzing and identifying malicious elements.

Optionally, the suspected malicious element may be atomically removed from the suspected file.

Optionally, the suspected file containing the suspected malware element may be blocked completely or otherwise quarantined.

Other systems may be provided for protecting multiple servers from hacking attacks by identifying security vulnerabilities common to more than one of the web servers and generating common protective elements such as fixes, patches or the like for execution on the vulnerable web servers.

### Web-based Malicious Software

As used herein, the term “URL” refers to a Uniform Resource Locator and is a reference, representing an address of a resource in the internet such as documents, files. and other resources on the World Wide Web.

As used herein, the term “malware” refers to malicious software as a general term for a variety of forms of hostile or intrusive software. “Malware” types may be differentiated according to criteria such as self-distribution, point of control, data stealing, level of protection and the like. The self-distribution is the capability of the malware to spread itself to other computers. Point of control refers to the capability of the malware to be controlled by a central remove server, for example its vulnerability to receiving commands, sending information, automatic updating and the like. Data stealing refers to the capability of the malware to send information from the computer to a remote server. Such malicious software is any code segment, program or file that is harmful to a user computer or to a server machine and may be used to disrupt computer operation, gather sensitive information, or gain access to private computer resources. Thus, malware may include computer viruses, worms, Trojan horses, key loggers, dialers, spyware and any programming that gathers information about a computer user without permission.

As used herein, the term “backdoor” refers to a point of access embedded in a targeted system or software program by an attacker giving remote access to the targeted system. Malware installed on systems for this purpose is often called a remote access Trojan, and can be used to install other malware on the system. Such program may allow a remote user to execute commands and tasks on your computer without your permission. These types of programs are typically used to launch attacks on other computers, distribute copyrighted software or media, or hack other computers.

Malwares may have various ways of spreading into a system, such as through Websites, social networks, pirated software, E-mails, removable media and the like.

Websites through web pages, social networks through sharing with third party software and applications and E-mails through attachments are particularly common to trigger malware attacks over your computing device.

As used herein, the term “malware quarantined” refers to a file identified as containing a malware element and is being moved to another non-standard folder. Optionally, the moved filed may be renamed. Optionally, the file may possibly be marked as “hidden” or resetting file permissions (depending on the operating system) such that the quarantined file cannot be opened by normal system processes. Optionally, the file may further be encrypted or encoded.

It is noted that the malware quarantine option of an infected file may contribute to avoid false positives. For example, if malware detection wrongly flags a file as “infected”, restoring the file from a quarantine status is possible, while deleting the file may cause the system to stop, if the file has critical functionality.

It is further noted that that anything in quarantine is safely segregated from the rest of computer and cannot run from there, thus it can not do any harm.

### Server Website Scanning

Server website scanning is related to another aspect of the current disclosure, operable to perform data scanning from “the inside”, by mapping the website file system structure (referring to static files and dynamic files, generated upon receiving client requests), opening files to identify and handle possible security vulnerabilities, if accessibility to the website is granted. This method may allow identification of a broader scope of security vulnerabilities, including potential backdoor security holes.

It is noted that when a backdoor is identified in a file, the system may be configured to disallow access to this file.

Accordingly, when a backdoor is identified in a file, the file itself is declared blocked and any access to such file will result in returning a 404 or 503 error web page.

It is further noted that the protection system is operable to filter malicious elements, block access to a file with malicious content and include additional protective elements into the suspected file to provide extra protection.

Optionally a suspected file may be quarantined in a specific non-standard zone.

Optionally a suspected file may be deleted.

### DESCRIPTION OF THE EMBODIMENTS

It is noted that the systems and methods of the disclosure herein are not necessarily limited in application to the details of construction and the arrangement of the components or methods set forth in the description or illustrated in the drawings and examples. The systems and methods of the disclosure may be capable of other embodiments or of being practiced or carried out in various ways.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

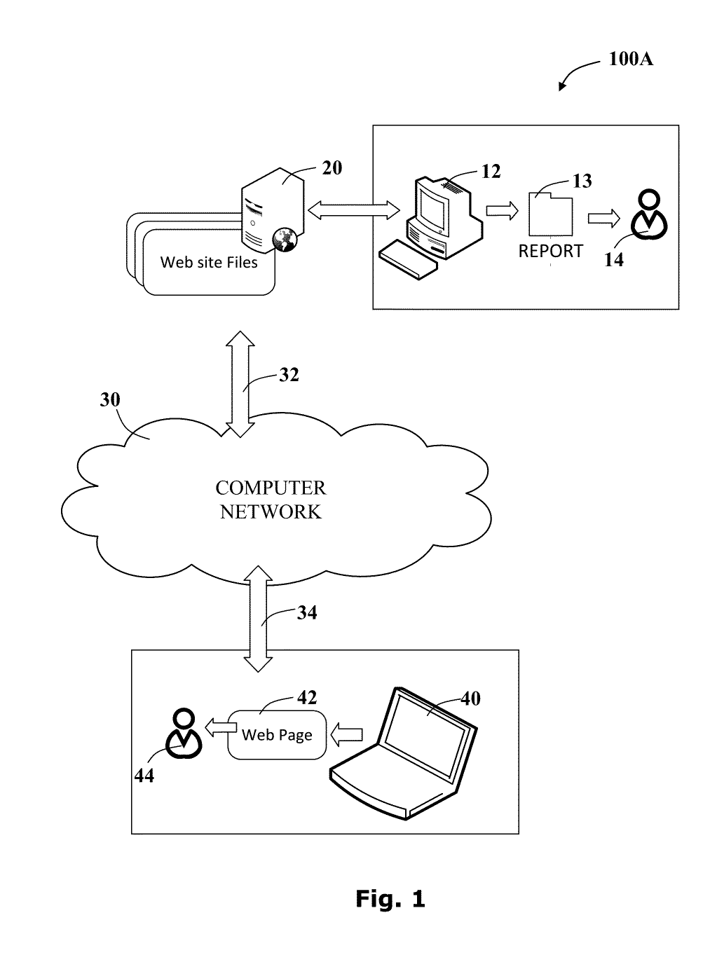

Reference is now made to FIG. 1, which schematically represents a protection system 100A for protecting a web server 20 from hacking attacks. The web server 20 is operable to connect to a computer network 30 such as the World Wide Web, internet, intranet, local area network or the like, via a network connection 32. The web server 20 is operable to host at least one website and may be accessible remotely. A remote user computing device 40 may be in communication with the computer network 30 via another connection 34 is having access to at least one website files of the web server 20 via the computer network 30.

It will be appreciated that such a web server 20 may be at risk of security attacks such as various malware attacks from remote computers. Accordingly, a protection system 100A may be provided to identify potential security vulnerabilities on the web server 20 before they are exploited, causing damage or linked to potential harmful networked resources.

The protection system 100A comprises a computing device 12, possibly the web server 20 itself, a personal computer or a laptop computer and the like, operable to use a data scanner to scan the web server 20 and to generate a user-friendly web-based malware report 13 for a system manager 14. The web-based malware report 13 may indicate all security vulnerabilities identified by the data scanner such that the system manager 14 may implement patches, fixes or the like as appropriate.

It is noted that that computing device 12 may possibly be the web server 20 itself, another computer having direct wired accessibility or may be a remotely connected computer (a personal computer, a laptop computer, a tablet and the like) authorized to access the web server 20.

Additionally or alternatively, the web-based malware report 13 may be used as an input to an automatic rules generator (not shown) to create a rule based module (not shown), possibly uploaded to a protection agent component (not shown) associated with the user computing device 40.

Additionally or alternatively, the web-based malware report 13 may be used as an input to an automatic process to allow editing of the infected files to remove the malicious software code or to quarantine the infected files.

It will be further appreciated that such a computing device 40 may be at risk of attacks whenever an internet connection is established by user 44 to access the website internet pages 42, automatically generated by the web server 20 as a response to user 44 requests. Protection on the computing device 40 side may be available through a protection agent (not shown), optionally perform rule based filtering logic to remove potential suspected malware code or URLs, as described hereinafter.

### Protective Agent and Enforcement

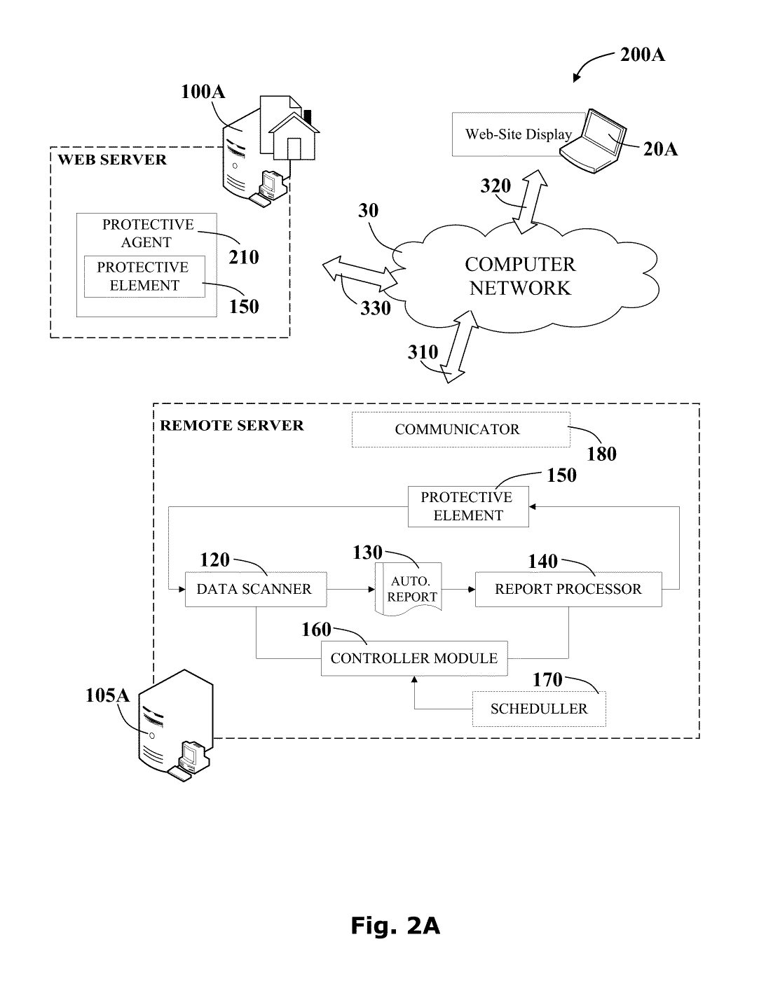

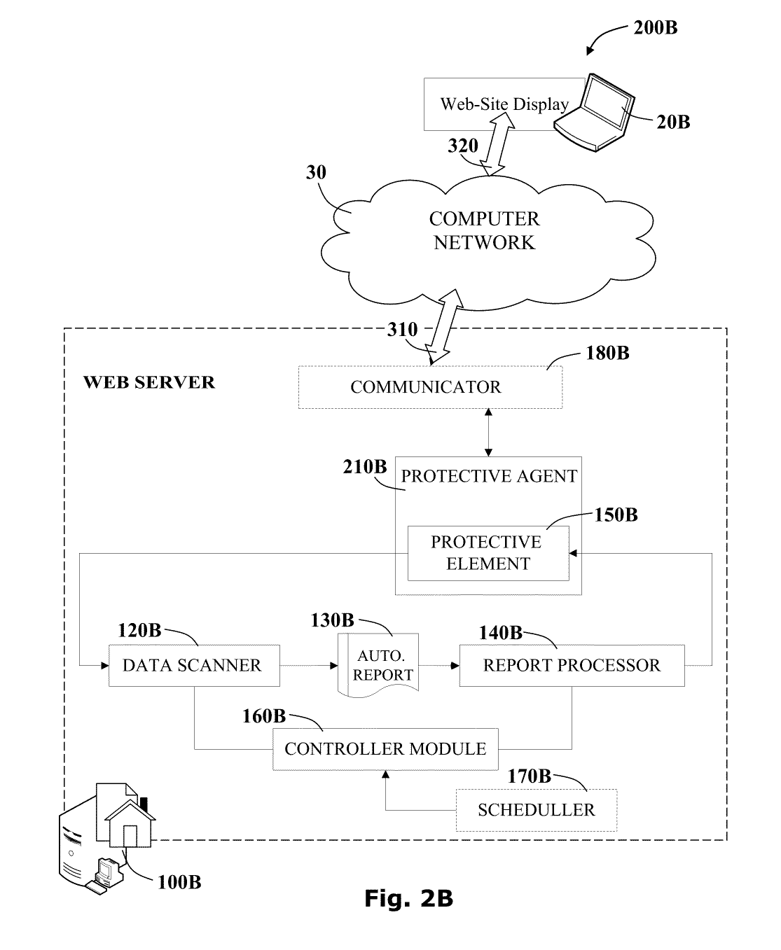

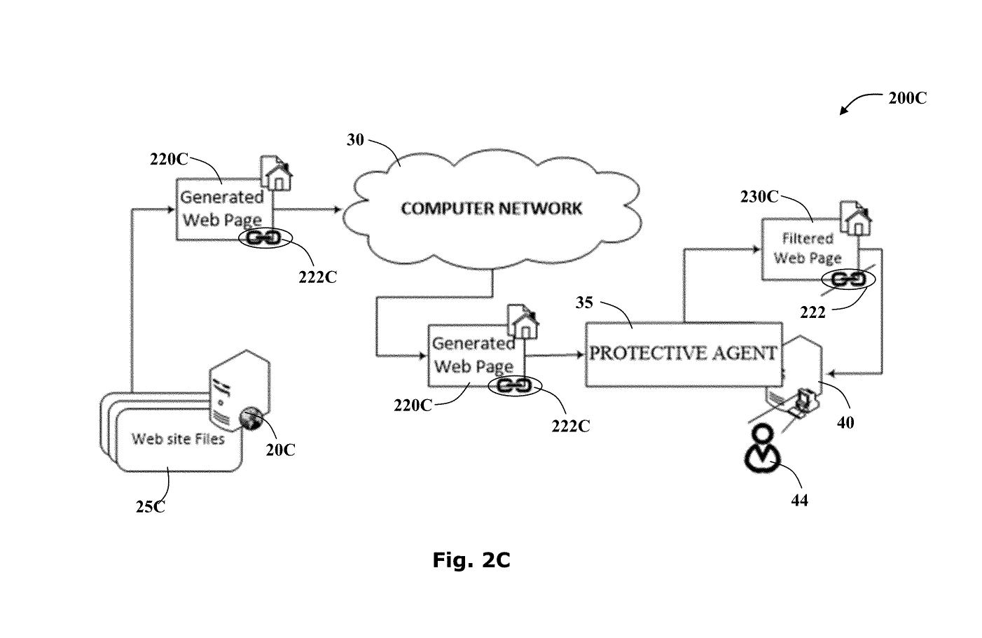

FIGS. 2A-B are block diagrams illustrating the system components for protecting malware attacks of a computing device, providing web based protective elements operable on a web server protective agent. It is noted that FIGS. 2A-B show the protective agent as operable on the web server itself, but the process of generating the rule based protective elements is operable and controlled via a remote server 105A as shown in FIG. 2A. FIG. 2B represent the comprehensive system operable on a web server 100B.

Reference is now made to FIG. 2A schematically illustrating a block diagram representing a protection system 200A for protecting a user computing device 20A from hacking attacks. As described herein, the protection system 200A may be operable and controlled from a remote server 105A and configured to identify security vulnerabilities on a web server 100A, providing protective elements therefor. The protective elements are operable to execute on a protective agent 250 associated with the user computing device 20A.

The protection system 200A may include a remote server 105A comprising a data scanner 120, a report processor 140, a controller 160 and a web server 100A comprising a protective agent 210 operable to execute at least one protective element 150. The data scanner 120 of the protection system 200A may be operable to map and scan the file system of the web server 100A, to identify at least one web-based malware in at least one file associated with at least one website hosted by the web server 100A. The protection system is further operable to produce an automated web-based malware report 130 providing data associated with at least one web-based malware.

The report processor 140 may be operable to receive the automated report 130 from the data scanner 120, to analyze the automated report 130 and to generate at least one protective element 150 directed towards removing or quarantining at least one identified web-based malware. Various protective elements 150, providing rule based logic may be generated, as appropriate, so as to prevent exploitation of the web-based malware. For example, an indication for a malware may be found in “http://website.com/index.php” file, having an <iframe> (an inline frame used to embed another document within the current HTML document) with a malicious URL leading to a potential harmful networked resource. The rule based logic would remove the malicious URL (optionally the <iframe> all together) by generating a rule associated with the malicious URL (or the <iframe> as a whole) for this specific file (index.php), as described hereinafter in FIG. 2C.

It is particularly noted that unlike the user friendly web-based malware report 13 described hereinabove above in relation to FIG. 1, the automated web-based malware report 130 generated by the data scanner 120 is generally a machine readable report configured such that it may be transferred to a report processor for analysis.

The controller 160 may be configured and operable to manage the data scanner 120 and/or the report processor 140. Accordingly, the controller 160 may instruct the data scanner to initiate scanning activity, for example, by determining a regular timed schedule for scanning, or by instructing the data scanner 120 to initiate the scanning activity when so prompted by a manager or the like.

Optionally, the scanning activity of the data scanner 120 may be initiated according to a default schedule determined by the scheduler 170 connectable to the controller 160. Further, the scanning schedule may be configured to suit requirements by editing the default schedule setting.

Furthermore, the controller 160 may be operable to receive the automated report 130 from the data scanner 120 and to transfer the automated report 130 to the report processor 140. Alternatively, the data scanner 120 may be configured to pass the automated report 130 directly to the report processor 140.

The protection system 200A may further include a communicator 180 for communicating with the web server 100A. The communicator 180 may be used to communicate at least one protective element 150 of the rule based logic to the protective agent 210 via communication channels 310 and 330 to/from the computer network 30. Accordingly, the controller 160 may manage the communicator 180, or may itself serve as the communicator.

Commonly, the protective agent 210 is operable to execute on a web server 100A. Variously, in some embodiments, the protective agent 210 may be executed on a remote computer system connectable to the web server. Optionally, the protective agent 210 may be executed on the user computing device 200 which is operable to communicate with the protective agent 210.

It is noted that scanning the web-site file system may include mapping the associated directory structure, and further following each URL of the websites, simulating user's behavior. Thus, fetching of all web pages associated with a specific URL and further perform search within every fetched web page to identify malware presence.

It is particularly noted that, the protective agent 210 may be operable to receive web pages from the web-server 100A and perform web-based malware removal or quarantine according to the rule based logic, as described hereinafter.

Where appropriate, some embodiments may use different configurations of the web-based malware protection system. For example, as described herein, FIG. 2B schematically illustrates a protection system fully operable on a web server.

FIG. 2B is a block diagram schematically representing a protection system 200B for protecting a user computing device 20B from hacking attacks. The protection system 200B may be configured to identify security vulnerabilities on the web server 100B and provide protective elements therefor, operable on a protective agent 210B associated with the user computing device 20B. The protection system 200B may include a data scanner 120B, a report processor 140B, a controller 160B and a protective agent 210B comprising at least one protective element 150B. The data scanner 120B of the protection system 200B may be operable to map and scan the file system of the web server 100B, to identify at least one web-based malware in at least one file of at least one website hosted by the web server 100B. Further, an automated web-based malware report 130B may be produced to provide data associated with at least one web-based malware.

The report processor 140B may be operable to receive the automated report 130B from the data scanner 120B, to analyze the automated report 130B and to generate at least one protective element 150B directed towards removing or quarantining at least one identified web-based malware. Various protective elements 150B, providing rule based logic may be generated, as appropriate, so as to prevent exploitation of the web-based malware.

It is noted that the protection system 200B may further include a communicator 180B for communicating with the user computing device 200. The communicator 180B may be used to communicate the protective element 150B of the rule based logic to the protective agent 210B via communication channels 310 and 320 to/from the computer network 30. Accordingly, the controller 160B may manage the communicator 180B, or may itself serve as the communicator.

Reference is now made to FIG. 2C schematically representing a system block diagram 200C for protecting a user computing device from malware attacks. The system 200C includes a website represented by a set of website pages 25C (static or dynamically generated in response to a client request) installed on a remote web server 20C, a protective agent 35 installed on the web server machine, operable to drive the security logic via a protective element such as a rule base software module. The website may be accessible by a user computing device 40.

Optionally, the protective agent 35 may be remotely connectable to the web server via a communication channel (not shown) accessible via the computer network 30.

Optionally, the protective agent 35 may be installed on the computing device 40.

It is noted that the web server protection logic may be operable to perform data scanning of the website file system structure. Possibly, the data scanning may use various mapping options of the website file system structure. Further, searching may be initiated to identify malware presence in any file of the scanned website system, and generating a malware data scanning report. The malware data scanning report may be moved to a report module operable to analyze the data scanning report and produce rule based logic by generating specific rules based upon the security vulnerabilities indicated in the malware data scanning report. For example, the report may have an indication for a malware found in “http://website.com/index.php” file, having an <iframe> (an inline frame used to embed another document within the current HTML document) with a malicious URL leading to a potential harmful networked resource.

In this situation, the rule based logic may add the logic to remove the malicious URL (optionally, delete the <iframe> section all together) by generating at least one rule associated with the malicious URL (or the <iframe> as a whole) for the particular web file (index.php). Each time, the protective agent 35, upon receiving the web file (index.php) will apply the associated rule(s), removing the malicious URL from the web file and forward the filtered file to the requesting client.

The software of the web server 20C, may respond to a client request by providing a static web page or by generating a dynamic web page. For example, the file http://website.com/index.php is a dynamic file, generated by the web server 20C.

The generated dynamic web page 220C, may include a malicious URL 222C and may be analyzed prior to transmitting the web page 220C to the user computing device 40 via the computer network 30. The received web page 220C is first identified by the protective agent 35 installed on the web server 20C, optionally on another machine), which in turn applies the rule based access control logic (not shown), to remove the malicious URL and forwarding a filtered web page 230C, allowing the user access to the filtered web page 230C, clean of security vulnerabilities.

It is noted that the current solution provides first-aid and immediate automatic technical solution preventing a user from being infected by the malware component. This may allow further, in time, manual cleanup process of the web server 20 web pages and files.

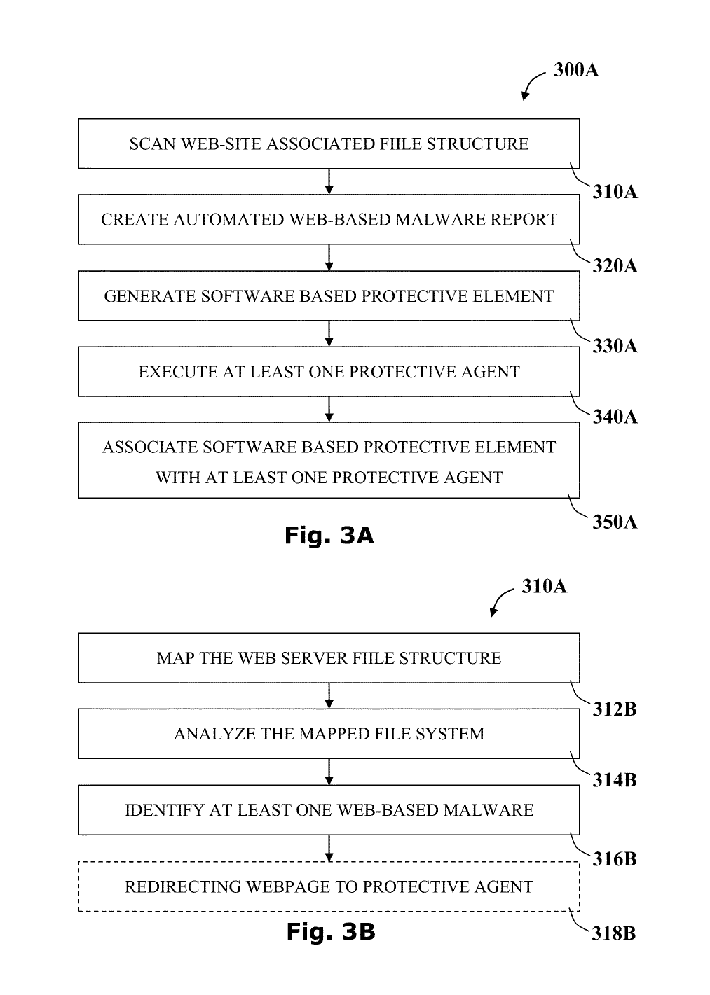

Reference is now made to the flowchart of FIG. 3A illustrating a possible method 300A representing a process for generating a software based protective element providing rule-based access control installable on a protective agent (FIG. 2, 35), associated with the web server to enable web page filtering and removal of at least one web-based malware.

The method 300A may include scanning at least one website file system associated with a web server—step 310A; creating an automated web-based malware report comprising data pertaining to at least one web-based malware—step 320A, to enable identification of possible malware vulnerabilities that may result from static web pages or dynamic pages; generating at least one software based protective element comprising at least one rule associated with at least one web-based malware, as identified in the automated report—step 330A as part of the rule based access control; executing at least one protective agent—step 340A, running on the web server machine. Optionally, the protective agent may run on a remote computer system in communication with the web server; and associating the generated rule based logic to the at least one protective agent—step 350A.

It is noted that the step of generating at least one software based protective element, may further generate a rule based logic file comprising at least one rule associated with the at least one web-based malware.

It is further noted that the generated rule base logic may be applied by the protective agent (FIG. 2B, 35) to a web page generated (static or dynamic) upon allowing to perform filtering and removing possible malicious URLs or the like.

It is noted that the rules are associated with at least one web-based malware, how to handle (filter/delete/quarantine and the like) the web server generated web pages, and various related parameters. For example, a web page of http://website.com/contact.php may include a malicious URL, directing the user upon clicking to an undesired location. Thus, each time the rule modules, when applied to such a web page will search for the malicious URL, and the filtered web page when received by the user will be excluded of malicious URL.

Reference is now made to the flowchart of FIG. 3B illustrating a possible method 312A representing a process for scanning the website associated file structure.

The method 312A includes: mapping the web server file system structure—step 312B; analyzing the mapped file system structure—step 314B; and identifying at least one web-based malware—step 316B. Optionally, redirecting at least one web page to the at least one protective agent for performing the desired preventative action according to the rule based logic—step 318B.

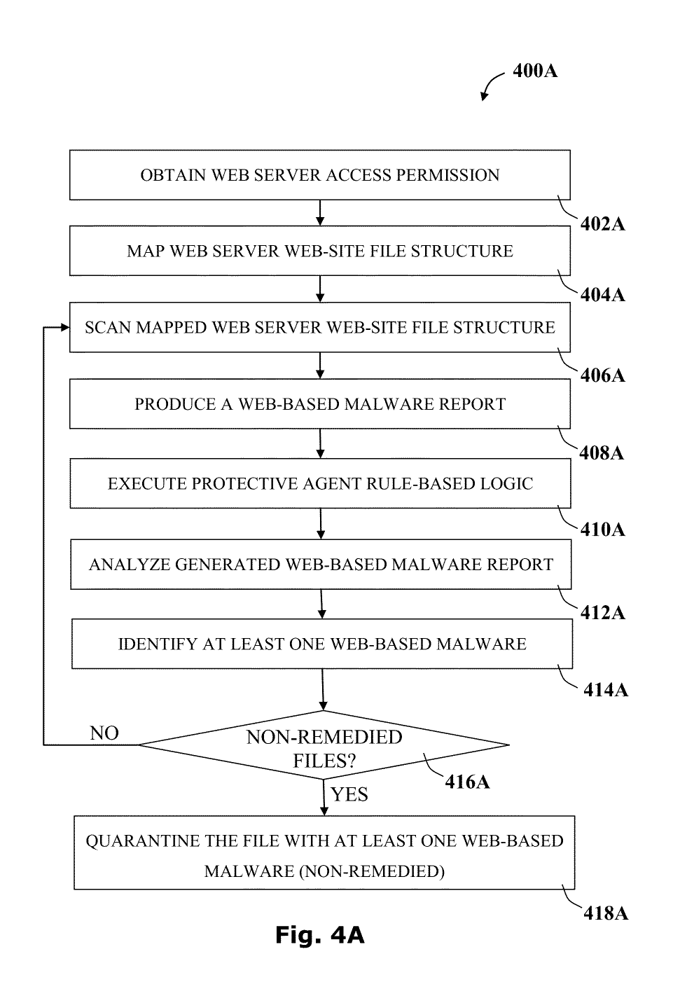

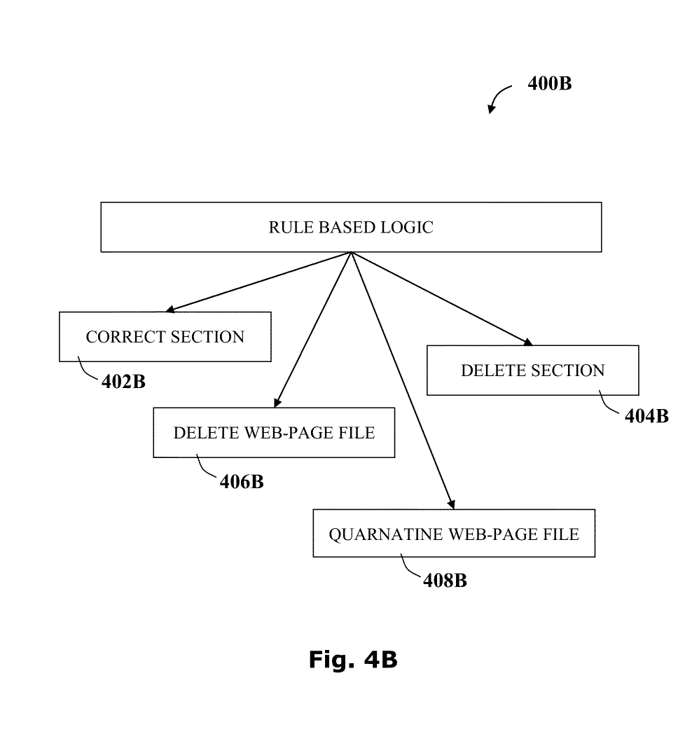

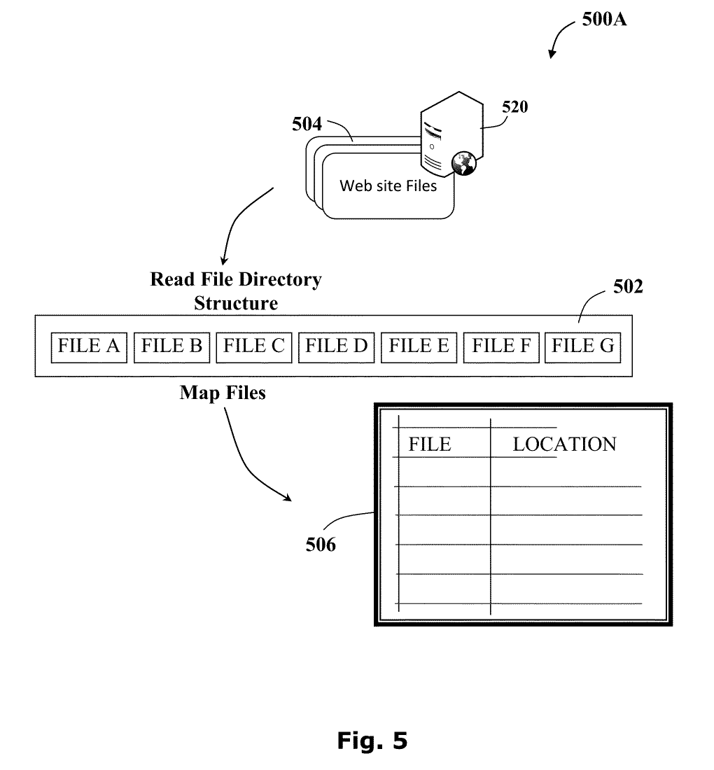

Reference is now made to the flowchart of FIG. 4A representing a possible method 400A for analyzing a web server file directory structure. The mapping of the associated website file structure may allow to protect against malware attacks such as described herein. The method includes: obtaining web server access permission—step 402A, if protection module is not residing on the web server itself; mapping web server associated web-site file directory structure (FIG. 5) into an indexing table—step 404A; scanning all web server files using the file indexing table—step 406A; producing a web-based malware report of all detected vulnerabilities—step 408A; executing protective agent application to perform the rule-based logic—step 410A; performing analysis of the generated web-based malware report—step 412A, optionally, opening web server files for possible remedy; identifying at least one vulnerability—step 414A; testing if non-remedied files exists—step 416A; and quarantining the identified file(s) containing malicious content—step 418A, unless remedy or removal of the malicious content is successful.

Reference is now made to FIG. 4B, representing rule based logic options 400B of a possible set of preventative actions in response to identification of a web-based malware by the protective agent.

The protective agent may be associated with at least one protective element associated with a rule based logic comprising at least one rule associated with at least one security venerability. Each rule may encode instructions configured to apply a preventative action to the at least one system vulnerability associated with said at least one web page.

The rule based logic may include a preventative action for correcting at least a section of the at least one web page containing the at least one system vulnerability—402B;

The rule based logic may include preventative action for deleting at least a section of the at least one web page containing the at least one system vulnerability—404B;

The rule based logic may include preventative action for deleting at least one file encoding of the at least one web page—406B; and

The rule based logic may include preventative action for quarantining at least one file encoding of the at least one web-page in a non-standard zone—408B.

It is noted that the protective agent may also be configured to return an appropriate error code or an erroneous web-page accordingly.

Reference is now made to FIG. 5, showing a schematic block diagram for a mechanism 500A providing web server vulnerability analysis using a file indexing tool.

The mechanism 500A includes at least one directory structure 502 of a web server 520 containing a set of files 504 which includes the data providing the logic for the website(s) associated with the web server 520. Additionally, an indexing table 506 reflects the mapped file system structure of the web server file directory, allowing to locate a file for various functions such as report generation, searching, searching and replacing and the like.

The web server file directory 502 may include a set of files; FILE A through FILEG, where each file may be a web server code file, a script file, an HTML file, a document file, an image file and the like. Additionally or alternatively, a file may represent an additional sub-directory containing another set of files.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

What is claimed is:

1. A protection system for protecting at least one computing device from malicious software attacking, said at least one computing device in communication via a computer network with at least one web server hosting at least one website and operable to generate at least one web page in response to receiving a data request, the protection system comprising:
at least one data scanner operable to scan a file system associated with said at least one website, to identify at least one web-based malware vulnerability, and further operable to generate an automated web-based malware vulnerability report comprising data pertaining to said at least one web-based malware vulnerability; and
at least one report processer operable to analyze said automated web-based malware vulnerability report and further operable to generate at least one software based protective element;
wherein said at least one software based protective element is associated with at least one protective agent.

2. The protection system of claim 1, wherein said at least one protective agent is installed on said at least one web server.

3. The protection system of claim 1, wherein said at least one protective agent is installed on a remote server connectable to said at least one web server via said computer network.

4. The protection system of claim 1, wherein said at least one protective agent is in communication with said at least one web server via said computer network.

5. The protection system of claim 1, wherein said at least one software based protective element comprises at least one rule based logic file, said at least one rule based logic file comprising at least one rule associated with said at least one web-based malware vulnerability and operable to prevent exploitation of said at least one web-based malware vulnerability.

6. The protection system of claim 5, further comprising at least one communicator operable to communicate with said at least one protective agent.

7. The protection system of claim 5, wherein said at least one protective agent is operable to receive said at least one web page and to generate at least one filtered web page according to said at least one rule based logic file.

8. The protection system of claim 5, wherein said at least one rule comprises instructions to apply a preventative action to said at least one system vulnerability associated with said at least one web page.

9. The protection system of claim 8, wherein said preventative action comprises correcting at least a section of said at least one web page containing said at least one system vulnerability,

10. The protection system of claim 9, said preventative action being selected from:
deleting at least a section of said at least one web page containing said at least one system vulnerability;
deleting at least one file encoding said at least one web page; and
quarantining at least one file encoding said at least one web-page in a non-standard zone.

11. The protection system of claim 1, further comprising a controller operable to manage said at least one data scanner and said at least one report processor.

12. The protection system of claim 6, further comprising a controller operable to manage said at least one data scanner, said at least one report processor and said at least one communicator.

13. The protection system of claim 11, wherein said controller is operable to instruct said at least one data scanner to initiate scanning activity.

14. The protection system of claim 11, wherein said controller is operable to receive said automated web-based malware vulnerability report from said at least one data scanner and to transfer said automated report to said at least one report processor.

15. The protection system of claim 11, wherein said controller is operable to receive said at least one rule based logic file from said at least one report processor and further associate said at least one rule based logic file to said at least one protective agent.

16. The protection system of claim 11, wherein said controller is operable to send at least one web page to said at least one computing device in response to said web server receiving a data request.

17. A method for protecting, in an improved manner, at least one computing device from a malicious software attack, said computing device in communication with at least one web server via a computer network and operable to access at least one website installed on said at least one web server, said method comprising:
said web server, scanning a file system structure associated with said website to identify at least one web-based malware vulnerability;
said web server, creating an automated web-based malware vulnerability report comprising data pertaining to said at least one web-based malware vulnerability;
said web server, generating at least one software based protective element;
said web server, executing at least one protective agent;
said web server, associating said at least one software based protective element with said at least one protective agent.

18. The method of claim 17, wherein said step of generating at least one software based protective element, comprises:
said web server, generating a rule based logic file comprising at least one rule associated with said at least one web-based malware vulnerability.

19. The method of claim 17, wherein said step of scanning a file system structure configuration, further comprises:
said web server, mapping said file system;
said web server, analyzing mapped file system; and
said web server, identifying at least one web-based malware vulnerability.

20. The method of claim 17, further comprising the step of redirecting said at least one web page to said at least one protective agent.
